(19) United States
(12) Patent Application Publication
(10) Pub. No.: US 2025/0383240 A1
(43) Pub. Date: Dec. 18, 2025

(54) Devices and methods for measuring surface temperature

(71) Applicant: Teknologian tutkimuskeskus VTT Oy, Espoo (FI)

(72) Inventors: Shahin Tabandeh, Espoo (FI); Sara Pourjamal, Espoo (FI)

(21) Appl. No.: 18/877,284

(22) PCT Filed: Jun. 6, 2023
(86) PCT No.: PCT/FI2023/050324

§ 371 Date: Dec. 20, 2024

(30) Foreign Application Priority Data
Jul. 1, 2022 (FI) 20225622

(51) Int. Cl. G01K 1/08

(52) U.S. Cl. CPC G01K 1/08

(57) ABSTRACT

According to an example aspect of the present invention, there is provided a device for measuring surface temperature of an object. The device comprises a contact surface to be placed against a surface of the object. The device further comprises a chip having a substrate and a sensing element on the substrate such that the sensing element is in thermal contact with the contact surface by thermal conduction through the substrate. A housing is attached to the chip and has an air inlet and an air outlet. A cavity is provided inside the housing between the air inlet and the air outlet, the cavity comprising a first portion in contact with the surface of the object and a second portion in contact with the sensing element. The cavity defines an air flow path from the air inlet through the first portion to the air outlet such that the second portion of the cavity remains outside the air flow path.

### FIELD

The invention relates to measuring surface temperature of an object by means of a device placed in physical contact with the measured object.

### BACKGROUND

Photonic and optomechanical contact thermometry is discussed in publication: Briant, Tristan, Stephan Krenek, Andrea Cupertino, Ferhat Loubar, Rémy Braive, Lukas Weituschat, Daniel Ramos et al. “Photonic and Optomechanical Thermometry.” Optics 3, no. 2 (2022): 159-176.

### SUMMARY OF THE INVENTION

The purpose of the invention is to reduce sources of measurement error in at least some embodiments of measurement arrangements.

The invention is defined by the features of the independent claims. Some specific embodiments are defined in the dependent claims.

According to a first aspect of the present invention, there is provided a device for measuring a surface temperature of an object. The device comprises a contact surface to be placed against a surface of the object to be measured. The device further comprises a chip having a substrate and a sensing element on the substrate such that the sensing element is in thermal contact with the contact surface by thermal conduction through the substrate. The device also comprises a housing attached to the chip and having an air inlet and an air outlet. The device further comprises a cavity inside the housing and between the air inlet and the air outlet. The cavity comprises at least a first portion, which is in contact with the surface of the object, and a second portion, which is in contact with the sensing element. The cavity defines an air flow path from the air inlet through the first portion to the air outlet such that the second portion of the cavity remains outside the air flow path.

According to a second aspect of the present invention, there is provided a method for measuring the surface temperature of an object with the device according to any one of the embodiments of the invention. The method comprises:
placing the contact surface of the device against the surface of the object such that thermal conduction occurs between the object and the sensing element through the substrate and an air flow is induced through the cavity along the air flow path;
waiting for a period of time to allow the sensing element to reach a thermal equilibrium; and
obtaining a measurement value from the sensing element.

### BRIEF DESCRIPTION OF THE DRAWINGS

FIG. 1 illustrates a device in accordance with at least some embodiments of the present invention;

FIG. 2 is a schematic cross-sectional view of a device in accordance with at least some embodiments of the present invention;

FIG. 3 is a schematic cross-sectional view of a device in accordance with at least some other embodiments of the present invention;

FIG. 4 is a schematic cross-sectional view of a device in accordance with at least some further embodiments of the present invention;

FIG. 5 illustrates a chip of a device in accordance with at least some embodiments of the present invention;

FIG. 6 illustrates an equivalent thermal circuit of a measurand-sensor interaction in accordance with at least some embodiments of the present invention; and

FIG. 7 illustrates a device in accordance with at least some embodiments of the present invention from a different viewing angle.

### EMBODIMENTS

The embodiments aim at reducing uncertainty of the measurements by bringing the temperature of the air in contact with the sensing element closer to the temperature of the measurand, i.e. the object to be measured. This is achieved by shaping the cavity inside the housing and around the sensing element such that an air flow inside the cavity brings heat from the measurand to the vicinity of the sensing element without the air flow being in contact with the sensing element. Instead, a volume of air in contact with the sensing element remains stagnant or vorticose such that the air in contact with the sensing element is not substantially mixed with the air flow during the measurement.

The embodiments relate to measuring surface temperature by means of a sensing element. The temperature is measured, for example, by photonic contact thermometry. The embodiments are useful for accurate measurements and calibration purposes, for instance. One application of the embodiments is characterization of sensors against the reference surface temperature. Because of the accuracy requirements, the embodiments contain arrangements for reducing sources of measurement error.

The embodiments of the invention are particularly useful in photonic contact thermometry using silicon ring resonators and tuneable laser-based spectroscopy. Photonic contact thermometry is discussed in publication: Briant, Tristan, Stephan Krenek, Andrea Cupertino, Ferhat Loubar, Rémy Braive, Lukas Weituschat, Daniel Ramos et al. “Photonic and Optomechanical Thermometry.” Optics 3, no. 2 (2022): 159-176.

In order to characterize sensors against the reference surface temperature, thermostats are widely used in the prior art. However, intrinsic uncertainty sources are limiting the performance at least in some embodiments. The inventors have now noticed that in some embodiments, apart from the reference temperature uncertainty levels, main sources of uncertainty associated with the sensors' optical readout are the effect of the intrinsic temperature gradient, the fiber-to-chip coupling, and, more importantly, temperature drop at the contact interface. This effect arises from the temperature difference between the surface and the surrounding air. At least some embodiments address and minimize these uncertainty sources.

The embodiments include geometrically defined air passages embedded in a housing cap for the thermostat. This can reduce the uncertainty components in characterizing surface thermometers, e.g. thermometric quantum and photonic sensors, for instance. The device can be designed such that an isothermal ridge is provided and the sensing element is placed in the middle of the isothermal ridge. This takes advantage of the heating effect of the ridge's walls to improve the uniformity of temperature around the thermometer chip. At least some of the embodiment decrease the uncertainty of the read-out protocol for surface thermometers and present a passive and reliable compensation of such errors.

Considering the characterization setup of the surface thermometers, e.g. resistance temperature detectors, thermocouples, thermistors, thermometric quantum and photonic sensors, openings are needed for optical characterization and fiber-to-chip coupling which yields to the intrinsic convective heat drains from the upper side of the on-chip thermometric sensors. At least some of the embodiments guide an air flow passively based on the natural convection and make a free vortex or stagnant air on the top part of the sensor.

Classical uncertainty contributions for bigger conventional probes are typically minimized by active compensation of the heat flux through the probe's metal stem, which is not applicable to the on-chip integrated thermometers like quantum and photonic sensors due to the size and geometry. In contrast, these terms are normally present in the uncertainty budget, or remained uncharacterized, although this is one order of magnitude bigger than other uncertainty components and thus governs the uncertainty level of the sensor.

When testing some of the embodiments, we have noticed a significant reduction in the uncertainty in characterizing surface thermometers, e.g. resistance temperature detectors, thermocouples, thermistors, thermometric quantum and photonic sensors, Even as high as 92% reduction in the uncertainty has been shown in our tests. Therefore, the embodiments can directly improve the performance and accuracy of the device.

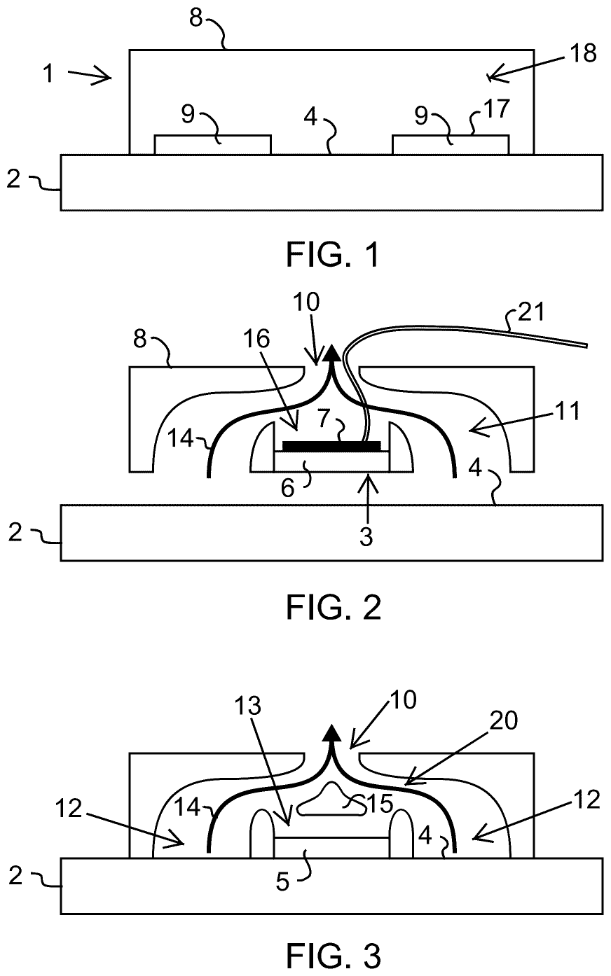

FIG. 1 shows a device 1 for measuring surface temperature according to at least some embodiments. FIG. 1 presents a side view of one outer face of the device 1. In FIG. 1, the device 1 is against the surface 4 of the object 2 that is to be measured. The device 1 comprises a housing 8. FIG. 1 shows one side of the housing 8 with air inlets 9. Air inlet 9 is an opening in the sidewall or surface of the housing 8 between the lower edge 17 of the side surface and the surface 4 to be measured. The air inlet 9 is located such that it remains open when the device 1 is placed against the surface 4 of the object 2. The object to be measured is also called as a measurand.

FIG. 2 is a schematic cross-sectional view of the device 1 according to at least some embodiments. In FIG. 2, the device 1 is in an elevated position and not in contact with the surface 4 of the object 2 to be measured. The contact is formed by lowering the device 1 and placing the contact surface 3 of the device 1 against the surface 4 of the object 2. The device also has a chip in a recess 16 inside the housing 8. The chip comprises a substrate 6 and a sensing element 7 on the substrate 6. The chip is oriented such that the sensing element 7 is in thermal contact with the contact surface 3 by thermal conduction through the substrate 6. The chip is located such that when the contact surface 3 of the device 1 is placed against the surface 4 of the object 2, a face of the substrate 6 comes in contact with the object 2. When the substrate 6 is in contact with the object 2, the sensing element 7, located on the opposite face of the substrate 6, is in thermal contact with the object 2 by thermal conduction through the substrate 6. Thus, the substrate is between the object 2 and the sensing element 7. FIG. 2 also shows a cavity 11 inside the housing 8 and an air outlet 10. FIG. 2 also shows an optical fibre 21 connecting the sensing element 7 with measuring equipment outside the device 1. FIG. 2 shows also an air flow path 14 along the which air flow is induced from the air inlets to the air outlet 10 when the device is placed in the measurement position against the surface 4.

In addition to the optical fibre 21 shown in FIG. 2, the device can comprise other contacts to the sensing element 7, such as electrical contact lines. In FIG. 2, the optical fibre 21 connection to the sensing element 7 is also affected by the air flow, which compensates for the thermal bridge formed by the optical fibre 21. In case other contacts are made between the sensing element 7 and external devices, these contact lines can also be led through the air flow path 14 to compensate for the thermal bridge effect in embodiments, in which this is considered beneficial.

FIG. 3 is a schematic cross-sectional view of the device 1 according to at least some embodiments. In FIG. 3, the device 1 is in contact with the surface 4 of the object 2 to be measured. FIG. 3 shows a chip 5 in less detail than FIG. 2. However, the chip 5 also comprises a substrate 6 and a sensing element 7. FIG. 3 also shows a deflector 15 located in the cavity 11 for guiding the air flow such that the desired air flow path 14 is obtained through the cavity 11. The cavity 11 comprises a first portion 12 in contact with the surface 4 of the object 2. The cavity also comprises a second portion 13 in contact with the sensing element of the chip 5. FIG. 3 also shows a third portion 20 of the cavity. The third portion is the portion of the cavity 11 that connects the first portion 12 to the air outlet 10 on a top surface 19 of the housing (top surface 19 shown in FIG. 7).

As shown in FIGS. 2 and 3, the cavity 11 defines the air flow path 14 from the air inlet through the first portion 12 to the air outlet 10 such that the second portion 13 of the cavity remains outside the air flow path 14. In FIG. 2, the second portion 13 of the cavity is formed inside the recess 16.

The contact surface 3 can be formed by a back face of the chip 5, or the back surface substrate 6 of the chip, as shown in FIGS. 2 and 3. Alternatively, a coating layer (not shown) can be provided on the back face of the 5 such that the coating layer forms at least part of the contact surface 3. The coating layer is preferably made of a material that is a good thermal conductor. It is also good if the coating layer can conform to the surface 4 of the object 2, which can be achieved by using an elastic material, for instance.

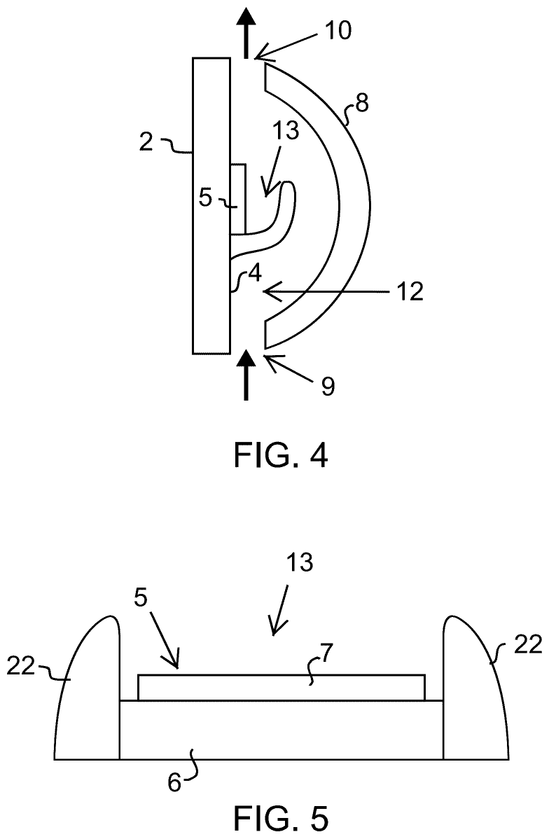

FIG. 4 shows a device intended for measuring lateral surfaces of objects 2. FIG. 4 shows an air inlet 9 to the first portion 12 of the cavity inside the housing 8 and in contact with the measured surface 4. The second portion is in contact with the chip 5 and the air flow through the cavity to the air outlet 10. The function of the device of FIG. 4 corresponds to the devices intended for measuring horizontal surfaces.

FIG. 5 is an enlarged schematic view of chip 5, such as the chip used in FIGS. 2-4. The chip comprises a substrate 6 and a sensing element 7 manufactured on the substrate 6. FIG. 5 shows also a protrusion 22 around the chip. The protrusion 22 is shaped such as to participate in directing the air flow to take the desired path and/or forming the second portion 13 of the cavity, in which the air is stagnant and/or vorticose. The protrusion 22 is optional, and in some other embodiment, the air flow can be controlled by other structural elements. The protrusion 22 can be manufactured as part of the housing 8 or a package prepared around the chip, for instance. In any case, the protrusion 22 can also be used to attach the chip to the structure of the housing 8 with supporting structures (not shown in figures). A similar protrusion 22 is also shown in FIGS. 2 and 3. In FIG. 4, the protrusion extends further and continues as a deflector towards its tip.

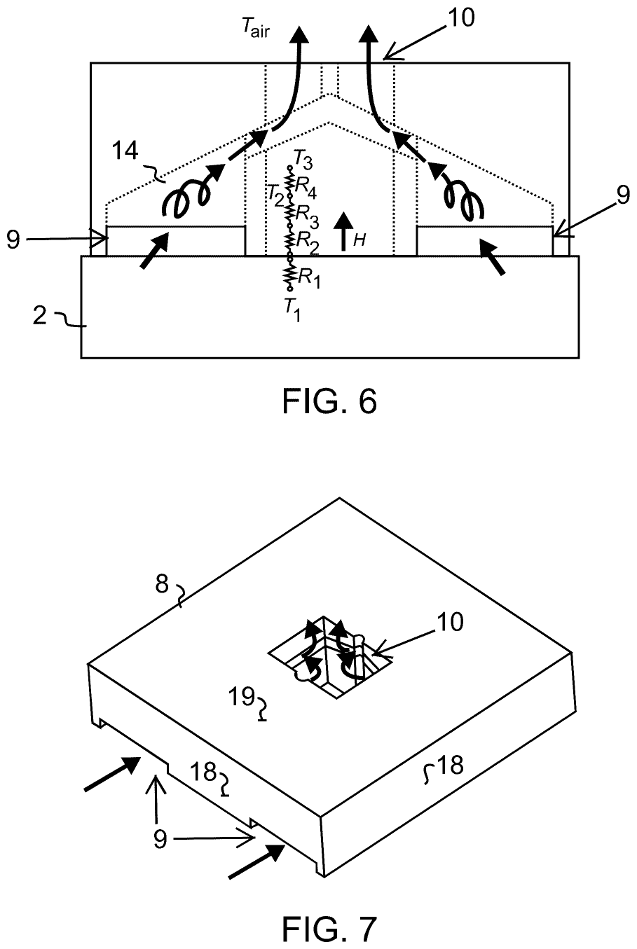

FIG. 6 depicts the equivalent thermal circuit of the measurand-sensor interaction. Heat transfers from the hot object 2 to the sensor via thermal resistance of the measurand (R1), thermal contact resistance between bodies (R2), the thermal resistance of the sensor (R3), and thermal resistance representing convective and radiative drains (R4) which is proportional to the difference between the sensor upper part surface temperature (T2) and that of the air in its vicinity (T3). The air flow 14 from inlet 9 to outlet 10 minimizes the differences between T3 and T1 and, consequently, the heat flux (H) brings T2 as close as possible to T1.

FIG. 7 shows the device 1 according to at least some embodiments from a different angle. FIG. 7 shows the housing 8. The housing 8 has a top surface 19 and side surfaces 18. Air inlets 9 are located in two opposing side surfaces 18 (inlets in the back side not shown) and an air outlet 10 is provided on the top surface 19.

As described above, embodiments provide a device 1 for measuring the surface temperature of an object 2. The device 1 comprises a contact surface 3 to be placed against a surface 4 of the object. The contact surface preferably allows a good mechanical contact with the surface 4 of the object 2 to reduce the thermal contact resistance over the interface. The device comprises a chip 5 having a substrate 6 and a sensing element 7 on the substrate such that the sensing element is in thermal contact with the contact surface by thermal conduction through the substrate. This means that the sensing element 7 is located at the opposite face, i.e. a front face, of the chip 5, and the back face of the chip faces towards the surface 4 of the object. According to an embodiment, the substrate 6 of the chip 5 is in direct mechanical contact with the surface 4 of the object. According to another embodiment, a contact layer is provided between the substrate 6 of the chip 5 and the surface 4 of the object.

The device comprises a housing 8 attached to the chip and having an air inlet 9 and an air outlet 10. The device comprises a cavity 11 inside the housing between the air inlet and the air outlet such that air can flow through a portion of the cavity 11 from the air inlet 9 to the air outlet 10. The cavity comprises a first portion 12, which is in contact with the surface 4 of the object 2, and a second portion 13 in contact with the sensing element 7. The cavity being in contact with the surface 4 of the object 2 or the sensing element 7 means the cavity is that air inside the cavity is in contact with these elements. Thus, these elements delimit the air space of the cavity 11. The cavity 11 has a shape that defines an air flow path 14 from the air inlet 9 through the first portion 12 to the air outlet 10 such that the second portion 13 of the cavity remains outside the air flow path. The purpose of this shape is to create around the sensing element 7 an atmosphere, in which the temperature of the air is stable and close to the temperature of the sensing element 7. In other words, the volume of air in the second portion 13 is substantially stable and has its temperature close to the temperature of the sensing element 7. This reduces uncertainty of the measurement.

According to an embodiment, the stable atmosphere is created by forming the cavity such that when an air flow is induced from the air inlet to the air outlet, a volume of air in the second portion in contact with the sensing element remains stagnant. When the volume of air remains stagnant, the air within the volume does not move and does not mix with the air flow during the measurement. Stagnant air refers to the mass of air which remains in a fixed space for an extended time period.

According to another embodiment, the stable atmosphere is created by forming the cavity such that when an air flow is induced from the air inlet to the air outlet, at least one vortex is created inside the second portion in contact with the sensing element. When the volume of air is vorticose, the air within the volume contains at least one vortex such that the vortex remains within the volume of air and does not mix with the air flow during the measurement.

Herein, the second portion 13 refers to a portion of the cavity 11 including a volume of air that is in contact with the sensing element 7, wherein the thickness of the volume is for example between 50 micrometers and 10 millimeters, such as between 100 μm and 2 mm, or between 200 μm and 1 mm. In some embodiments, the second portion 13 is located in a recess 16 or is partially limited by other structures of the device.

In some embodiments, the sensing element 7 is located in a recess 16 and the sensing element 7 forms at least part of a bottom of the recess.

According to some embodiments, the device comprises at least one deflector 15 inside the housing 8 for directing the air flow path away from the second portion 13 of the cavity and the sensing element 7. The deflector may comprise at least one nozzle, pipe, lip, flap, wing, partial cover or a similar structure guiding the air flow. It is also possible to use a diffuser. In general, any surface forms that provide the desired air flow path can be used. The purpose is to reduce convective heat drains from the sensing element 7 and for this purpose create a stagnation point near the sensing element or a suitable vortex near the sensing element. The purpose is also to create a suitable air flow through the cavity to reduce the convective heat drains.

According to some embodiments, the air inlet 9 comprises at least one opening formed between a lower edge 17 of a side surface 18 of the housing and the surface of the object when the device is placed against the surface of the object. Thus, the inlet air flows through the opening between the lower edge 17 and surface 4 of the object to be measured. At the same time, the air flow is in contact with the surface 4 and its temperature gets closer to the temperature of the surface 4. Then, the air flow transports heat to the other parts in the housing. This structure helps in its part to the stabilize the atmosphere around the sensing element 7 and bring the temperature of the surrounding air (the volume of air in the second portion of the cavity) closer to the temperature of the measured surface 4. At least in some embodiments, the height of the air inlets 9 is for example 0.5-10 mm, such as 1-2 mm. The height of the air inlet 9 refers herein to the distance between the lower edge 17 of the side surface 18 of the housing and the surface 4 of the object 2 when the device is placed against the surface 4. Sufficiently small height of the air inlet 9 helps to provide a good thermal contact between the surface 4 of the object 2 and the air within the first portion 12 of the cavity 11. The height of the first portion 12 of the cavity 11 can be for example 0.5-20 mm, such as 1-10 mm or 2-5 mm.

According to some embodiments, the first portion 12 of the cavity is delimited by the air inlet 9, a portion of an internal surface of the housing 8 and an area of the surface 4 of the object when the device 1 is placed against the surface of the object 2. In these embodiments, air within the first portion 12 is in direct contact with the surface 4 of the measured object. This further enhances the effects discussed in the previous paragraph and thus provides for the creation of a good atmosphere around the sensing element 7.

According to some embodiments, the air outlet 10 comprises at least one opening formed in a top surface 19 of the housing 8.

According to some embodiments, the cavity 11 comprises a third portion 20 connecting the first portion 12 to the air outlet 10 such that the air flow path 14 goes from the air inlet 9 to the air outlet 10 through the first and third portions 12, 20 of the cavity, and the second portion 13 of the cavity opens to at least one of the first and third portion 12, 20 of the cavity without forming part of the air flow path 14. The second portion 13 of the cavity opens to at least one of the first and third portion 12, 20 in order to improve heat exchange to the volume of air in the second portion 13. At the same time, substantial flow of air between the second portion 13 and the rest of the cavity 11 is prevented by the form of the cavity 11 and the resulting air flow path 14.

According to some embodiments, the sensing element 7 comprises a micro-ring resonator.

According to some embodiments, the device 1 comprises an optical fibre 21 coupled to the sensing element 7 and extending outside the housing 1 through the second portion 13 of the cavity.

There is also provided a new method for measuring the surface temperature of an object with the device according to any one of the embodiments described above and/or shown in the drawings. The method comprises the steps of:
placing the contact surface of the device against the surface of the object such that the air outlet is located higher than the air inlet;
waiting for a period of time to allow the sensing element to reach a thermal equilibrium; and
obtaining a measurement value from the sensing element.

When the device is correctly placed against the surface of the object, thermal conduction occurs from the object to the sensing element through the substrate and additionally an air flow is induced through the cavity along the air flow path. Then, the air flow transports heat (or cold) from the surface of the object towards the air outlet inside the housing and helps to stabilize the measurement as discussed above with reference to the embodiments of the device.

According to an embodiment, the measurement is performed in ambient air such that the object is warmer than the ambient air. In this case, the contact surface of the device is placed against the surface of the object such that the air outlet is located higher than the air inlet. Then, thermal conduction occurs from the object to the sensing element through the substrate and an air flow is induced through the cavity along the air flow path such that the air flow transports heat from the surface of the object towards the air outlet inside the housing.

According to another embodiment, the measurement is performed in ambient air such that the object is colder than the ambient air. In this case, the contact surface of the device is preferably placed against the surface of the object such that the air outlet is located lower than the air inlet. Then, in the beginning of the measurement, the sensing element is usually warmer than the object to be measured and thermal conduction occurs from the sensing element to the object through the substrate. Also air flow is induced through the cavity along the air flow path such that the air flow cools the cavity inside the housing. Such an arrangement is achieved, for example, by means of the embodiment of FIG. 4 with an opposite orientation such that the air inlet 9 is placed above the air outlet 10.

The measured surface is usually at least substantially horizontal, which means within +/−15 degrees from the horizontal plane. However, it is also possible to measure vertical surfaces and surfaces in other orientation as long as the device is properly designed to provide the air outlet above the air inlet and sufficiently guide the air flow through the cavity 11.

According to some embodiments, the air flow is naturally induced due to the temperature gradient by warming or cooling of the air inside the cavity.

According to some embodiments, the volume of air in contact with the sensing element remains stagnant during the air flow.

According to some embodiments, the volume of air in contact with the sensing element is vorticose during the air flow without substantially mixing with the air flow.

The stagnant or vorticose air in the second portion of the cavity reduces temperature gradients at the sensing element and thus improves the measurement accuracy.

The embodiments can be used for measuring the surface temperature in surface thermometry.

The sensing element 7 can be, for example, a microring resonator, resistance temperature detectors, thermocouples, or thermistor. The sensing element 7 can be made on a single chip, for instance. The sensing element can contain more than one sensor. The chip can be made on a wafer, for example on a silicon wafer, using microfabrication manufacturing technologies.

The housing 8 can be made of plastic or silicon, for instance. According to an embodiment, both the chip 5 and the structures of the housing 8 are made of silicon. According to an embodiment, a housing is formed around the chip 5 using packaging technologies, such as chip-scale packaging, wafer-level packaging or larger-scale packaging.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and examples of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

The verbs “to comprise” and “to include” are used in this document as open limitations that neither exclude nor require the existence of also un-recited features. The features recited in depending claims are mutually freely combinable unless otherwise explicitly stated. Furthermore, it is to be understood that the use of “a” or “an”, i.e. a singular form, throughout this document does not exclude a plurality.

### REFERENCE SIGNS LIST

1 device for measuring surface temperature
2 object to be measured
3 contact surface of the device
4 surface of the object to be measured
5 chip
6 substrate of the chip
7 sensing element
8 housing of the device
9 air inlet
10 air outlet
11 cavity
12 first portion of the cavity
13 second portion of the cavity
14 air flow path
15 deflector
16 recess
17 lower edge
18 side surface of the housing
19 top surface of the housing
20 third portion of the cavity
21 optical fiber
22 protrusion

### CITATION LIST

### Non Patent Literature

Briant, Tristan, Stephan Krenek, Andrea Cupertino, Ferhat Loubar, Rémy Braive, Lukas Weituschat, Daniel Ramos et al. “Photonic and Optomechanical Thermometry.” Optics 3, no. 2 (2022): 159-176.

1. A device for measuring surface temperature of an object, the device comprising:
a contact surface to be placed against a surface of the object;
a chip having a substrate and a sensing element on the substrate such that the sensing element is in thermal contact with the contact surface by thermal conduction through the substrate;
a housing attached to the chip and having an air inlet and an air outlet, wherein the air inlet comprises at least one opening formed between a lower edge of a side surface of the housing and the surface of the object when the device is placed against the surface of the object;
a cavity inside the housing between the air inlet and the air outlet, the cavity comprising a first portion in contact with the surface of the object and a second portion in contact with the sensing element; and
wherein the cavity defines an air flow path from the air inlet through the first portion to the air outlet such that the second portion of the cavity remains outside the air flow path.

2. The device of claim 1, wherein the cavity is formed such that when an air flow is induced from the air inlet to the air outlet, a volume of air in the second portion in contact with the sensing element remains stagnant.

3. The device of claim 1, wherein the cavity is formed such that when an air flow is induced from the air inlet to the air outlet, at least one vortex is created inside the second portion in contact with the sensing element.

4. The device of claim 1, further comprising at least one deflector for directing the air flow path away from the second portion of the cavity and the sensing element.

5. The device of claim 1, wherein the second portion is located in a recess in the cavity.

6. The device of claim 5, wherein the sensing element forms at least part of a bottom of the recess.

7. (canceled)

8. The device of claim 1, wherein the air outlet comprises at least one opening formed in a top surface of the housing.

9. The device of claim 1, wherein the first portion of the cavity is delimited by the air inlet, a portion of an internal surface of the housing, and an area of the surface of the object when the device is placed against the surface of the object.

10. The device of claim 1, wherein the cavity comprises a third portion connecting the first portion to the air outlet such that the air flow path goes from the air inlet to the air outlet through the first and third portions of the cavity, and the second portion of the cavity opens to at least one of the first and third portion of the cavity without forming part of the air flow path.

11. The device of claim 1, wherein the sensing element comprises at least one micro-ring resonator, resistance temperature detector, thermocouple, thermistor, optical resonator and/or microwave resonator.

12. The device of claim 1, further comprising an optical fibre coupled to the sensing element and extending outside the housing through the second portion of the cavity.

13. The device of claim 1, wherein the air inlet is located such that it remains open when the device is placed against the surface of the object.

14. The device of claim 1, wherein the device is configured such that an air flow is induced through the cavity along the air flow path when the device is placed against the surface of the object.

15. A method for measuring surface temperature of a surface of an object, the method comprising:
providing a device comprising:
a contact surface;
a chip having a substrate and a sensing element on the substrate such that the sensing element is in thermal contact with the contact surface by thermal conduction through the substrate;
a housing attached to the chip and having an air inlet and an air outlet;
a cavity inside the housing between the air inlet and the air outlet, the cavity comprising a first portion and a second portion, wherein the second portion is in contact with the sensing element; and
wherein the cavity defines an air flow path from the air inlet through the first portion to the air outlet such that the second portion of the cavity remains outside the air flow path;
placing the contact surface of the device against the surface of the object such that thermal conduction occurs between the object and the sensing element through the substrate, and an air flow is induced through the cavity along the air flow path;
waiting for a period of time to allow the sensing element to reach a thermal equilibrium; and
obtaining a measurement value from the sensing element.

16. The method of claim 15, wherein the air flow is induced by warming or cooling of the air inside the cavity.

17. The method of claim 15, wherein the volume of air in contact with the sensing element remains stagnant during the air flow.

18. The method of claim 15, wherein the volume of air in contact with the sensing element is vorticose during the air flow without substantially mixing with the air flow.

19. A device for measuring surface temperature of an object, the device comprising:
a contact surface configured to be placed against a surface of the object;
a chip having a substrate and a sensing element on the substrate such that the sensing element is in thermal contact with the contact surface by thermal conduction through the substrate;
a housing attached to the chip and having an air inlet and an air outlet, wherein the air inlet comprises at least one opening formed between a lower edge of a side surface of the housing and the surface of the object when the device is placed against the surface of the object;
a cavity inside the housing between the air inlet and the air outlet, the cavity comprising a first portion in contact with the surface of the object and a second portion in contact with the sensing element; and
wherein the cavity defines an air flow path from the air inlet through the first portion to the air outlet such that the second portion of the cavity remains outside the air flow path.

20. The device of claim 19, wherein
the air outlet comprises at least one opening formed in a top surface of the housing;
the first portion of the cavity is delimited by the air inlet, a portion of an internal surface of the housing, and an area of the surface of the object when the device is placed against the surface of the object; and
the cavity comprises a third portion connecting the first portion to the air outlet such that the air flow path goes from the air inlet to the air outlet through the first and third portions of the cavity, and the second portion of the cavity opens to at least one of the first and third portion of the cavity without forming part of the air flow path.
